(19) United States
(12) Patent Application Publication
(10) Pub. No.: US 2019/0102765 A1
(43) Pub. Date: Apr. 4, 2019

(54) COMPUTER-IMPLEMENTED SYSTEM AND METHOD FOR CLIENT DATA REPORTING AND DATA CAPTURE

(71) Applicant: Welcomemat Services, Inc., Atlanta, GA (US)

(72) Inventor: Brian Mattingly, Atlanta, GA (US)

(73) Assignee: Welcomemat Services, Inc., Atlanta, GA (US)

(21) Appl. No.: 16/146,184

(22) Filed: Sep. 28, 2018

Related U.S. Application Data
(60) Provisional application No. 62/565,730, filed on Sep. 29, 2017.

(51) Int. Cl. G06Q 20/20; G06K 7/14; G06K 19/06

(52) U.S. Cl. CPC G06Q 20/208; G06K 7/1413; G06K 19/06037; G06K 19/06028; G06K 7/1417

(57) ABSTRACT

Embodiments of the present systems and methods may provide automated techniques for capture of data, such as purchasing selections and special offers, and client reporting of such data. For example, in an embodiment, a computer-implemented method for data capture may comprise generating a plurality of unique codes, each unique code corresponding to particular information, distributing the plurality of unique codes to a plurality of users, receiving a unique code, verifying the unique code is valid and unused, marking the unique code as used, and providing the particular information.

### CROSS-REFERENCE TO RELATED APPLICATIONS

This application claims the benefit of U.S. Provisional Application No. 62/565,730, filed Sep. 29, 2017, the contents of which are incorporated herein in their entirety.

### BACKGROUND

The present disclosure relates broadly and generally to a computer-implemented system and method for client data reporting and data capture.

As the provision of goods and services becomes more automated, the presence of human attendants, cashiers, etc. is becoming less common. Typically, automated point-of-sale terminals are provided, which may provide to a consumer functions such as selection of goods and services to be purchased. In addition, sellers often provide special offers such as discounts, subscription plans, promotions, giveaways, etc. Given a proliferation of such special offers, consumers may have difficulty selecting and entering particular special offers that they desire to utilize and that have been offered to them.

Accordingly, a need arises for techniques that may provide automated techniques for capture of data, such as purchasing selections and special offers, and client reporting and analysis of such data.

### SUMMARY

Embodiments of the present systems and methods may provide automated techniques for capture of data, such as purchasing selections and special offers, and client reporting of such data.

For example, in an embodiment, a computer-implemented method for data capture may comprise generating a plurality of unique codes, each unique code corresponding to particular information, distributing the plurality of unique codes to a plurality of users, receiving a unique code, verifying the unique code is valid and unused, marking the unique code as used, and providing the particular information.

In embodiments, the unique code may be received from a point-of-sale terminal and the particular information may indicate at least one of: an offer for goods or service to be provided and pricing information for the goods or services to be provided. The unique code may be scanned by a code reader included in or attached to the point-of-sale terminal. The plurality of unique codes may be distributed by printing at least one unique code on each of a plurality of printed items and distributing the printed items to a plurality of users. Particular information associated with a unique code provided to a user may be determined based on information relating to the user. The information relating to the user may include at least one of: an age, an income, an address, a housing type, a geographic location, a gender of the user, demographic information, and sociographic information.

In an embodiment, a system for data capture may comprise a processor, memory accessible by the processor, and computer program instructions stored in the memory and executable by the processor to perform generating a plurality of unique codes, each unique code corresponding to particular information, distributing the plurality of unique codes to a plurality of users, receiving a unique code, verifying the unique code is valid and unused, marking the unique code as used, and providing the particular information.

In an embodiment, a computer program product for data capture may comprise a non-transitory computer readable storage having program instructions embodied therewith, the program instructions executable by a computer, to cause the computer to perform a method comprising generating a plurality of unique codes, each unique code corresponding to particular information, distributing the plurality of unique codes to a plurality of users, receiving a unique code, verifying the unique code is valid and unused, marking the unique code as used, and providing the particular information.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 illustrates an exemplary system in which the present systems and methods may be implemented.

FIG. 2 is an exemplary flow diagram of a process, which may implement embodiments of the present methods, and which may be implemented in embodiments of the present systems.

FIG. 3 illustrates an exemplary printed item, in accordance with embodiments of the present systems and methods.

FIG. 4 illustrates an exemplary printed item, in accordance with embodiments of the present systems and methods.

FIG. 5 illustrates an exemplary printed item, in accordance with embodiments of the present systems and methods.

FIG. 6 illustrates an exemplary code reader, in accordance with embodiments of the present systems and methods.

FIG. 7 illustrates an exemplary output report, in accordance with embodiments of the present systems and methods.

FIG. 8 is an exemplary block diagram of a computer system in which processes involved in the embodiments described herein may be implemented.

### DETAILED DESCRIPTION

Embodiments of the present systems and methods may provide techniques for client data reporting and data capture. In exemplary embodiments, the system and method may comprise third party one-time use code point-of-sale (POS) or client database integration for reporting and data capture. This may be applied to both individual postcard mailings and to a cooperative mail piece that could include multiple offers from many different end-user clients. The exemplary system and method may be implemented using any suitable computing device, such as described further herein.

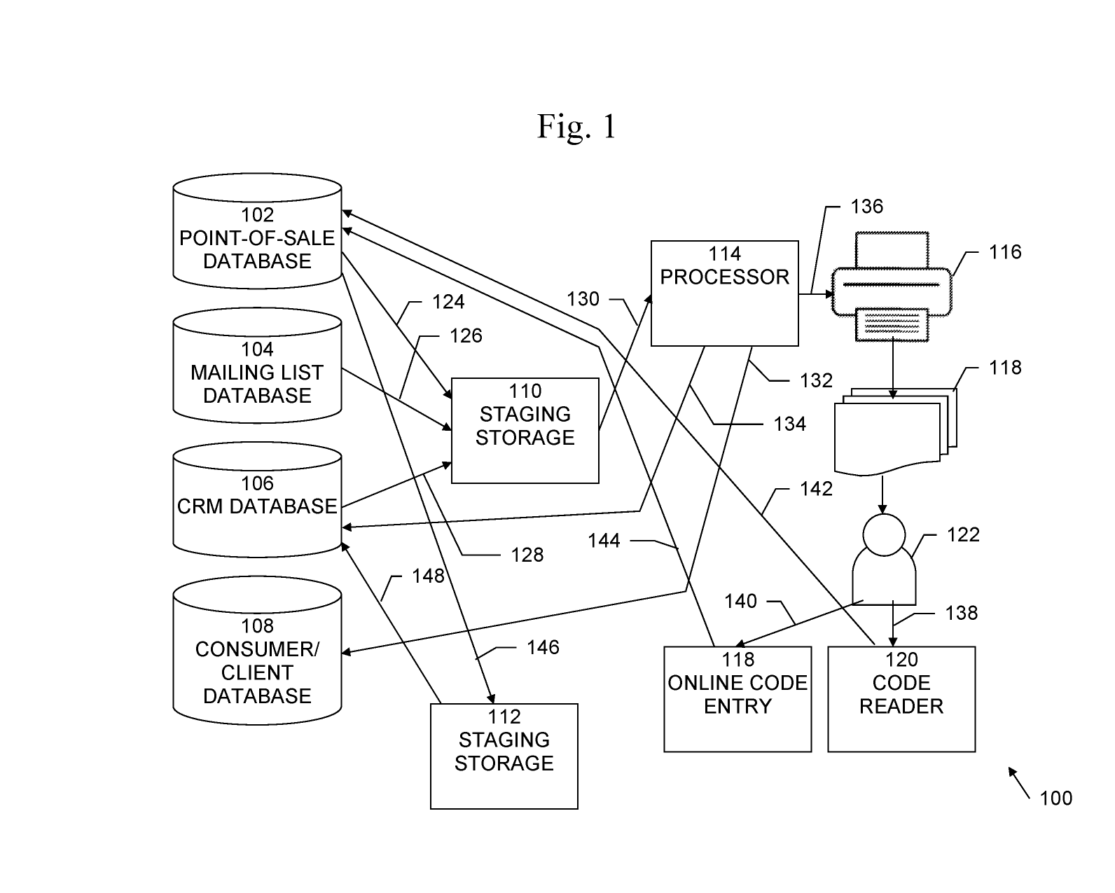

An exemplary system 100 in which the present systems and methods may be implemented is shown in FIG. 1. As shown in FIG. 1, system 100 may include a plurality of databases, such as point-of-sale database 102, mailing list database 104, customer relationship management (CRM) database 106, and consumer/client database 108. Databases 102-108 may be communicatively connected to other components, such as staging storage 110, 112, processor 114, printer 116, online code entry application 118, and code reader 120. Point-of-sale database 102 may provide the capability to generate unique use codes or promotion codes for each client, store information relating to each generated code, and send the generated code and/or information to other communicatively connected components.

Mailing list database 104 may provide the capability to store mailing list information relating to consumers, generate mailing lists from segments of the stored mailing list information for each client of system 100, and send the generated mailing lists to other communicatively connected components. Segmentation may include specific demographics, specific characteristics of the individual, life events of the individual, specific items regarding the individual and also radius and/or zip codes of interest.

CRM database 106 may provide the capability to store information relating to clients of system 100, as well as how those client are participating in mailings, offers, promotions, etc., and send the selected client information to other communicatively connected components.

Consumer/client database 108 may provide the capability to store information relating to consumers and clients of system 100, select stored consumer/client information, merge the selected consumer/client information with other received information, and send the merged information to other communicatively connected components.

Staging storage 110, 112 may be memory that provides intermediate storage of data from databases 102-108 or from other components. Processor 114 may provide the capability to receive data from databases 102-108 or from other components and to process the data to generate data to be printed, for example by printer 116, to form printed materials 118 to be provided to consumers 122, wherein such printed materials 118 may include information indicating one or more unique codes. Online code entry application 118 and code reader 120 may provide a consumer 122 with the capability to enter unique codes from printed materials 118 and to send such codes to components such as point-of-sale database 102.

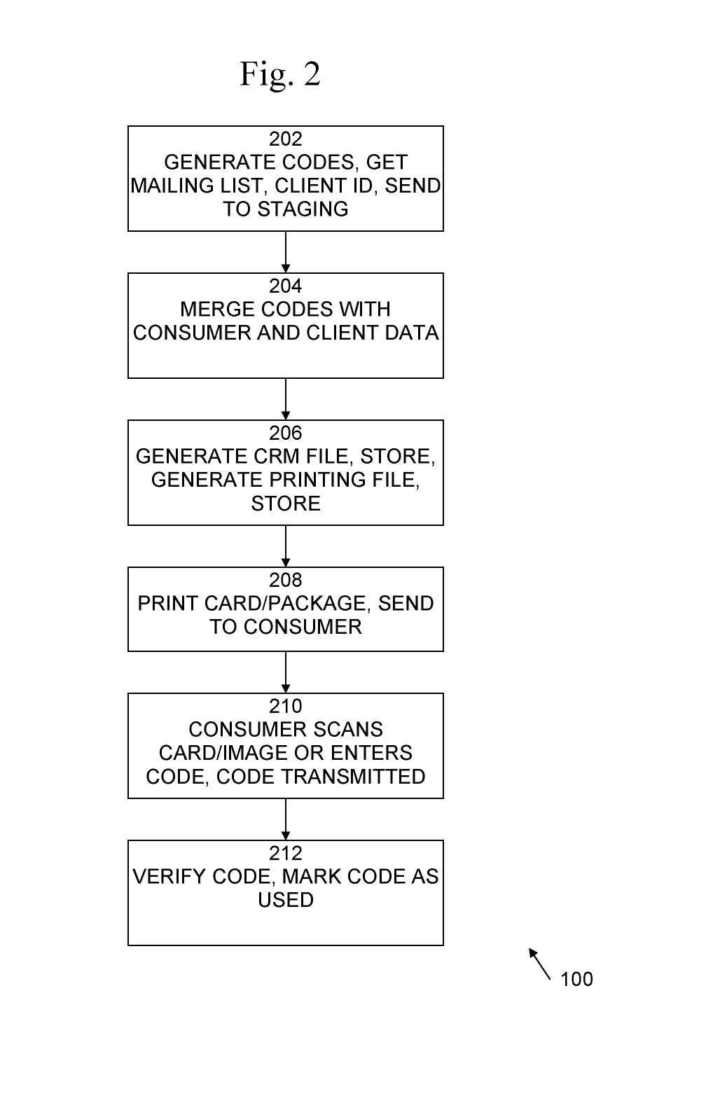

FIG. 2 is an exemplary flow diagram of a process 200, which may implement embodiments of the present methods, and which may be implemented in embodiments of the present systems. It is best viewed in conjunction with FIG. 1. Process 200 begins with 202, in which unique use codes or promotion codes 124 may be generated or created by POS database 102 for one or more clients, as indicated by client identification information. For each client, one or more mailing lists 126 may be generated by mailing list database 104 from segments of the stored mailing list information. Client identification information 128 may be selected by CRM database 106. The generated codes 124 from POS database 102, the generated mailing lists 126 from mailing list database 104, and the selected client identification information 128 from CRM database 106 may be sent to staging storage 110.

At 204, processor 114 may obtain 130 data 124, 126, 128 from staging storage 110 and may merge codes 124 with mailing list information 126 and client identification information 128 to form merged information 132, which may include codes, consumer addresses, names, and other information associated with each code, and a client and offer associated with each code. Merged information 132 may be stored in consumer/client database 108. At 206, processor 114 may further generate CRM information 134 for storage in CRM database 106, and may further generate consumer/client specific printing information 136. CRM information 134 may include records of all codes 124 and recipients of codes 124. Printing information 136 may be generated by combining data 124, 126, 128 to a graphically designed item to be printed. The unique code 124 for each item to be printed may be laid out in both human readable format and/or stored in a printed barcode to be scanned at the end user client POS or keyed in, either online or at a physical location. Once this print formatting software is run, printing information 136 may be generated.

At 208, printer 116 may use printing information 136 to print printed items 118, such as cards, flyers, brochures, offers, etc. Printing software may apply artwork and layout information to printed items 118 and may insert consumer/client specific printing information 136 into each printed item 118. Printed items 118 may be sent, mailed, handed out, or otherwise distributed to a plurality of consumers 122.

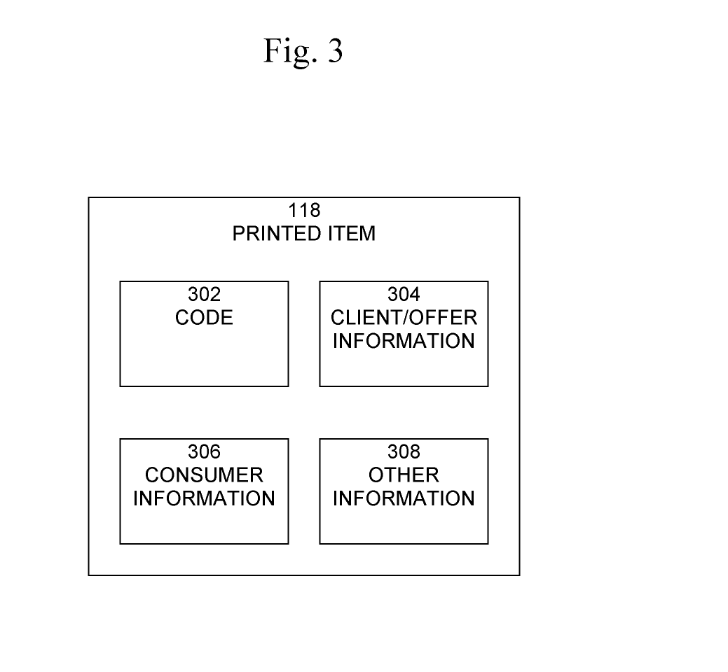

Referring to FIG. 3, an example of a printed item 118 is shown. In this example, printed item 110 include code information 302, client/offer information 304, consumer information 306, and other information 308. Code information 302 may include one or more unique use codes or promotion codes 124 generated by POS database 102. Code information 302 may be printed using any standard or proprietary code printing technology, such as bar codes, two-dimensional bar codes, QR codes, etc. Likewise, code information 302 may be printed textually, using alphanumeric characters. Client/offer information 304 may include information identifying the client, as well as client locations, products, and services, and may include information describing one or more offers available from the client. Consumer information 306 may include information identifying the consumer to whom an offer is made, as well as the consumer's mailing address for mailing of printed item 118. In embodiments, a particular consumer may be identified, while in other embodiments, consumers may be identified generally, such as “Resident”, etc. In embodiments, such as flyers that are handed out or are generally available, printed item 118 may include no identification of a consumer. Other information 308 may include any other information desired to be included in printed item 118, such as artwork, advertising information, etc.

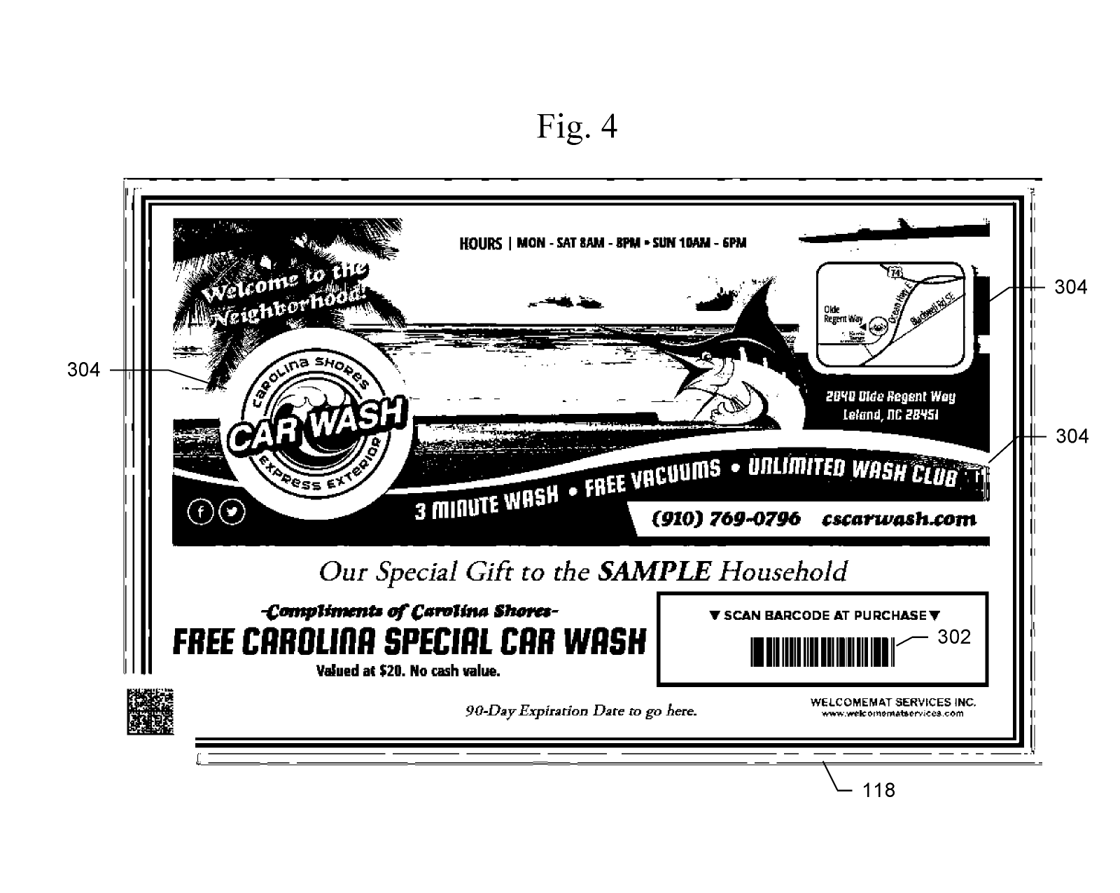

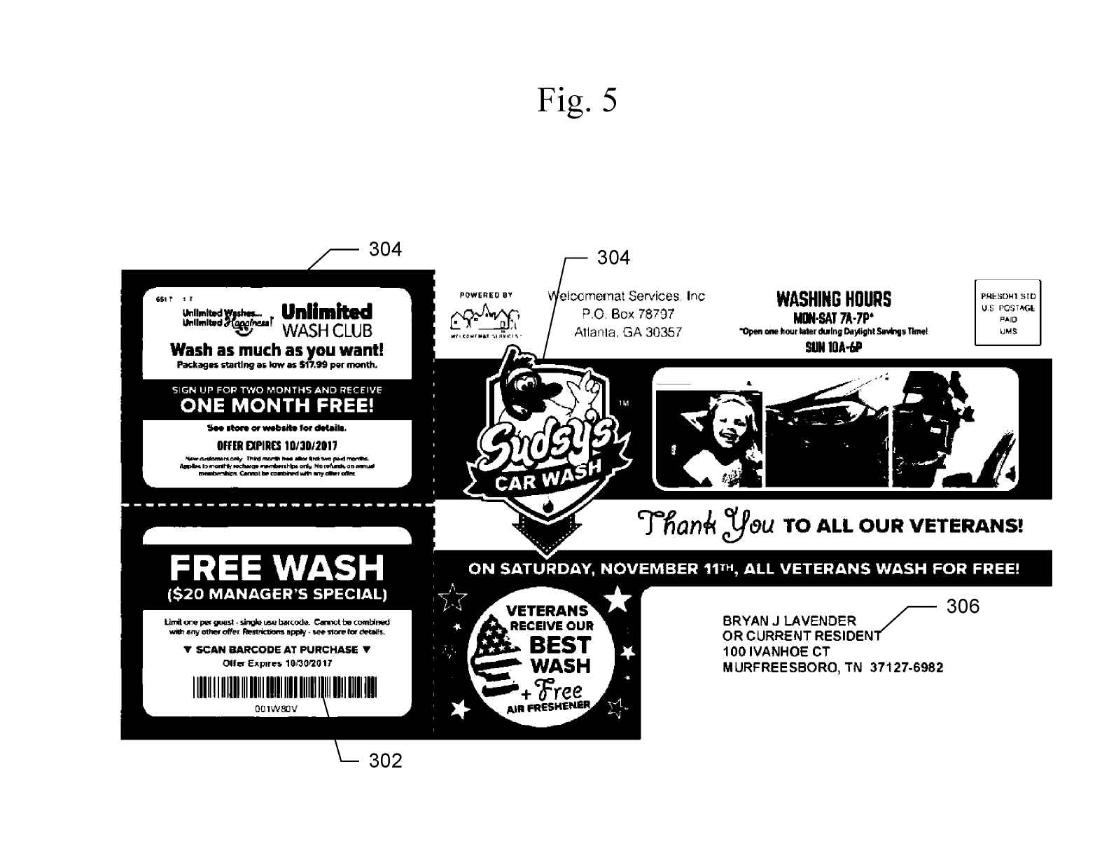

An example of a printed item 118 is shown in FIG. 4. This example includes code information 302 and client/offer information 304. An example of a printed item 118 is shown in FIG. 5. This example includes code information 302, client/offer information 304, and consumer information 306.

Returning to FIG. 2, at 210, a consumer 122 may scan or otherwise enter code information 302 present on a printed item 118. For example, consumer 122 may scan 138 code information 302, such as bar codes, two-dimensional bar codes, QR codes, etc., using code reader 120, or consumer 122 may enter 140 code information 302, such as a textual or numeric code using online code entry application 118. In embodiments, consumer 122 may use a mobile device, such as a smartphone, tablet, etc., to capture an image of code information 302 from printed item 118. Consumer 122 may then scan the captured image of code information 302 on the mobile device using code reader 120. Likewise, code information 302 may be communicated to consumer 122 in electronic form, such as an email or message, and code information 302 may be scanned directly from the email or message on the mobile device. Code readers 120 may be included in point-of-sale terminals and may be located in stores or other places of business, such as client locations, or locations where client products and services are sold or provided. Code information 302 may be directly scanned by consumer 122 or by employees of the client, store, etc. In embodiments, code information 302 may be entered manually at such locations, using, for example, a touchpad or keypad. In cases where the consumer is online at a website of a client, or website where client products and services are sold or provided, code information 302 may be entered by consumer 122 into the online application providing the website. The scanned 138 or entered 140 code information 302 may be sent 142, 144 to point-of-sale database 102. Typically, code information 302 is not sent directly from code reader 120 or online code entry application 118 to point-of-sale database 102, but is transmitted via one or more networks and/or backend systems or interfaces before ultimately being received at point-of-sale database 102.

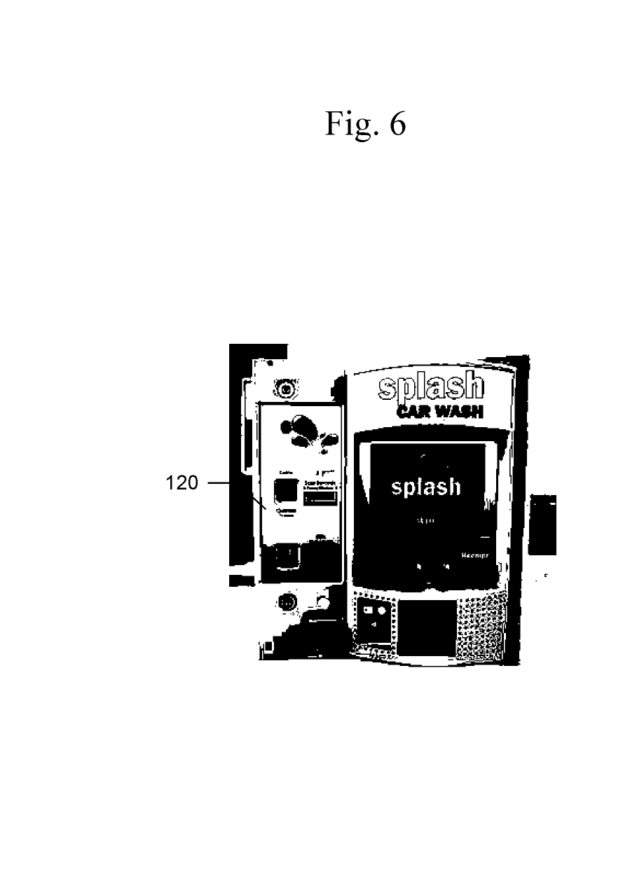

Referring to FIG. 6, an example of a code reader 120 is shown. In this example, code reader 120 is included in, or attached to, a client point-of-sale terminal at which consumer 122 can select for purchase and pay for client provided goods and services, as well as scan or enter code information 302.

Returning to FIG. 2, at 212, point-of-sale database 102 may look up stored information corresponding to code information 302, verify that code information 302 corresponds to a valid, unused code, and send an acknowledgement that code information 302 has been verified. Further, code information 302 may indicate, correspond to, or be accompanied by special offer information, such as particular goods or services to be provided and pricing information for the particular goods or services to be provided, such as a particular price, discount, or free offer. A point-of-sale terminal including code reader 120 may then configure the transaction according to the special offer information, such as by selecting particular goods or services to be provided and the price for the transaction. Once the code is scanned and transmitted as “used” to the point of sale, the code may be marked as used in point-of-sale database 102 so a consumer can't use the same offer again. For example, in the example shown in FIG. 4, a free carwash may be offered. Typically, such an offer is intended to be used only once. The provider of the service would not want customers to repeatedly use the offer. Also, once the code is scanned, point-of-sale terminal 120 may display a message to the customer, such as “Welcome to the neighborhood—enjoy your complimentary wash—don't forget to sign up for our unlimited wash plan.”

Point-of-sale database 102 may send data 146 to CRM database 106, either directly, or via 148 staging storage 112, indicating that code information 302 has been used. CRM database 106 may receive the used code data and may mark or flag code information 302 as used, and may tie the use of that particular code to a particular consumer 122. For example, if code information 302 was included on a card mailed to a particular consumer 122, the use of code information 302 may be tied back to the consumer 122 to whom the card was mailed. Likewise, if a particular code is used by a consumer identified by other means, such as use of a credit card, online entry of name and address, etc., the use of code information 302 may be tied back to the consumer 122 so identified.

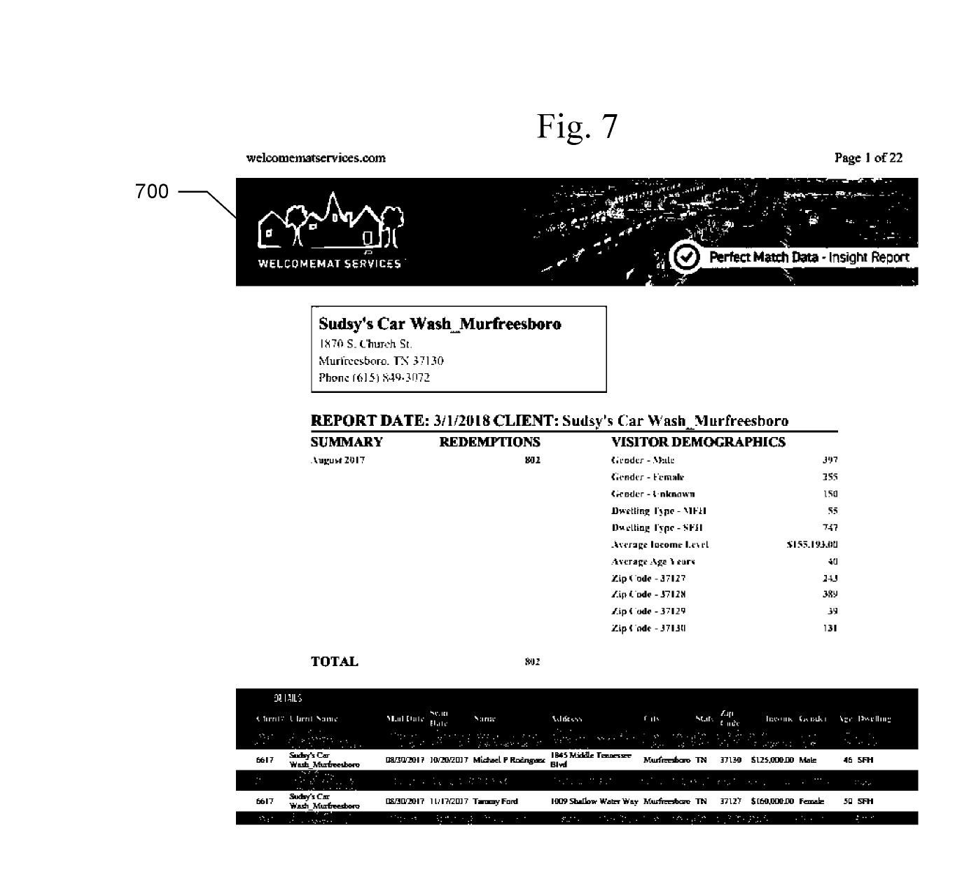

In embodiments, one or more output reports may be generated. For example, a report may be generated identifying the consumers 122 who used each code, along with demographic and statistical and aggregate information. For example, the report may include information such as the number of consumers 122 who used each promotion or offer, the total quantity of codes used, ages, incomes, addresses, housing types, etc. of consumers who used the codes, how many codes were redeemed, a summary by zip codes or other geographic parameters of where the redemptions came from, who redeemed the codes and demographic information regarding the redeeming mailing recipient including address, income, age, gender. Likewise, other demographic or sociographic information relating to the consumer, or to demographic categories may be used. The report may also be used to send second or additional mail pieces. etc. An example of an output report 700 is shown in FIG. 7.

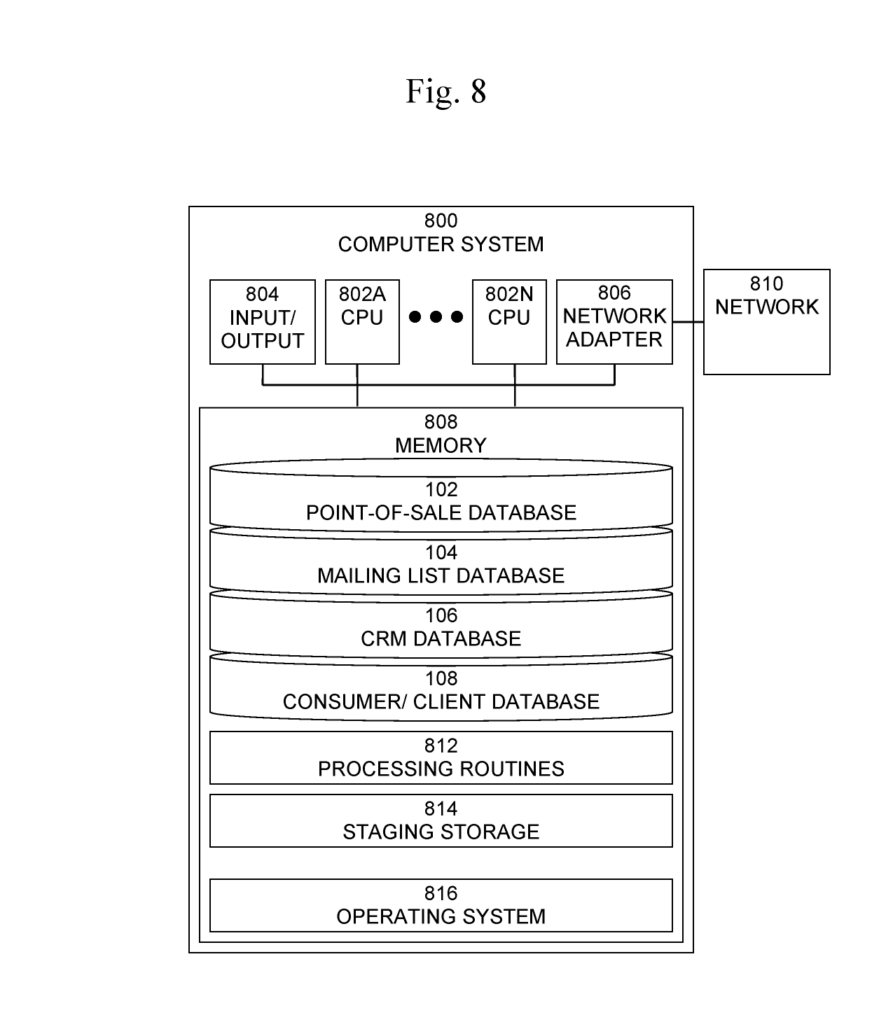

An exemplary block diagram of a computer system 802, in which processes involved in the embodiments described herein may be implemented, is shown in FIG. 8. Computer system 802 may be implemented using one or more programmed general-purpose computer systems, such as embedded processors, systems on a chip, personal computers, workstations, server systems, and minicomputers or mainframe computers, or in distributed, networked computing environments. Computer system 802 may include one or more processors (CPUs) 802A-802N, input/output circuitry 804, network adapter 806, and memory 808. CPUs 802A-802N execute program instructions in order to carry out the functions of the present communications systems and methods. Typically, CPUs 802A-802N are one or more microprocessors, such as an INTEL CORE® processor. FIG. 8 illustrates an embodiment in which computer system 802 is implemented as a single multi-processor computer system, in which multiple processors 802A-802N share system resources, such as memory 808, input/output circuitry 804, and network adapter 806. However, the present communications systems and methods also include embodiments in which computer system 802 is implemented as a plurality of networked computer systems, which may be single-processor computer systems, multi-processor computer systems, or a mix thereof.

Input/output circuitry 804 provides the capability to input data to, or output data from, computer system 802. For example, input/output circuitry may include input devices, such as keyboards, mice, touchpads, trackballs, scanners, analog to digital converters, etc., output devices, such as video adapters, monitors, printers, etc., and input/output devices, such as, modems, etc. Network adapter 806 interfaces device 800 with a network 810. Network 810 may be any public or proprietary LAN or WAN, including, but not limited to the Internet.

Memory 808 stores program instructions that are executed by, and data that are used and processed by, CPU 802 to perform the functions of computer system 802. Memory 808 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra-direct memory access (UDMA), or a small computer system interface (SCSI) based interface, or a variation or enhancement thereof, such as fast-SCSI, wide-SCSI, fast and wide-SCSI, etc., or Serial Advanced Technology Attachment (SATA), or a variation or enhancement thereof, or a fiber channel-arbitrated loop (FC-AL) interface.

The contents of memory 808 may vary depending upon the function that computer system 802 is programmed to perform. In the example shown in FIG. 8, exemplary memory contents are shown representing routines and data for embodiments of the processes described above. However, one of skill in the art would recognize that these routines, along with the memory contents related to those routines, may not be included on one system or device, but rather may be distributed among a plurality of systems or devices, based on well-known engineering considerations. The present communications systems and methods may include any and all such arrangements.

In the example shown in FIG. 8, memory 808 may include point-of-sale database 102, mailing list database 104, customer relationship management (CRM) database 106, and consumer/client database 108, processing routines 812, staging storage 814, and operating system 816. Point-of-sale database 102 may provide the capability to generate unique use codes or promotion codes for each client, store information relating to each generated code, and send the generated code and/or information to other communicatively connected components. Mailing list database 104 may provide the capability to store mailing list information relating to consumers, generate mailing lists from segment of the stored mailing list information for each client of system 100, and send the generated mailing lists to other communicatively connected components. CRM database 106 may provide the capability to store information relating to clients of system 100 and send the selected client information to other communicatively connected components. Consumer/client database 108 may provide the capability to store information relating to consumers and clients of system 100, select stored consumer/client information, merge the selected consumer/client information with other received information, and send the merged information to other communicatively connected components. Processing routines 812 may include software to implement the processing performed by processor 114, shown in FIG. 1. Staging storage 814 may include memory storage to implement the functionality of staging storage 110, 112, shown in FIG. 1. Operating system 816 may provide overall system functionality.

As shown in FIG. 8, the present communications systems and methods may include implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including Linux, UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A computer-implemented method for data capture comprising:
generating a plurality of unique codes, each unique code corresponding to particular information;
distributing the plurality of unique codes to a plurality of users;
receiving a unique code;
verifying the unique code is valid and unused;
marking the unique code as used; and
providing the particular information.

2. The method of claim 1, wherein the unique code is received from a point-of-sale system and the particular information indicates at least one of: an offer for goods or service to be provided and pricing information for the goods or services to be provided.

3. The method of claim 2, wherein the unique code is scanned by a code reader included in or attached to the point-of-sale terminal.

4. The method of claim 2, wherein the plurality of unique codes are distributed by:
printing at least one unique code on each of a plurality of printed items; and
distributing the printed items to a plurality of users.

5. The method of claim 2, wherein particular information associated with a unique code provided to a user is determined based on information relating to the user.

6. The method of claim 5, wherein the information relating to the user includes at least one of: a name, an age, an income, an address, a housing type, a geographic location, a gender of the user, demographic information, and sociographic information.

7. A system for data capture, the system comprising a processor, memory accessible by the processor, and computer program instructions stored in the memory and executable by the processor to perform:
generating a plurality of unique codes, each unique code corresponding to particular information;
distributing the plurality of unique codes to a plurality of users;
receiving a unique code;
verifying the unique code is valid and unused;
marking the unique code as used; and
providing the particular information.

8. The system of claim 7, wherein the unique code is received from a point-of-sale terminal and the particular information indicates at least one of: an offer for goods or service to be provided and pricing information for the goods or services to be provided.

9. The system of claim 8, wherein the unique code is scanned by a code reader included in or attached to the point-of-sale terminal.

10. The system of claim 8, wherein the plurality of unique codes are distributed by:
printing at least one unique code on each of a plurality of printed items; and
distributing the printed items to a plurality of users.

11. The system of claim 8, wherein particular information associated with a unique code provided to a user is determined based on information relating to the user.

12. The system of claim 11, wherein the information relating to the user includes at least one of: an age, an income, an address, a housing type, a geographic location, a gender of the user, demographic information, and sociographic information.

13. A computer program product for data capture, the computer program product comprising a non-transitory computer readable storage having program instructions embodied therewith, the program instructions executable by a computer, to cause the computer to perform a method comprising:
generating a plurality of unique codes, each unique code corresponding to particular information;
distributing the plurality of unique codes to a plurality of users;
receiving a unique code;
verifying the unique code is valid and unused;
marking the unique code as used; and
providing the particular information.

14. The computer program product of claim 13, wherein the unique code is received from point-of-sale software and the particular information indicates at least one of: an offer for goods or service to be provided and pricing information for the goods or services to be provided.

15. The computer program product of claim 14, wherein the unique code is scanned by a code reader included in or attached to the point-of-sale terminal.

16. The computer program product of claim 14, wherein the plurality of unique codes are distributed by:
printing at least one unique code on each of a plurality of printed items; and
distributing the printed items to a plurality of users.

17. The computer program product of claim 14, wherein particular information associated with a unique code provided to a user is determined based on information relating to the user.

18. The computer program product of claim 17, wherein the information relating to the user includes at least one of: an age, an income, an address, a housing type, a geographic location, a gender of the user, demographic information, and sociographic information.
